(19) United States
(12) Patent Application Publication
(10) Pub. No.: US 2018/0039610 A1
(43) Pub. Date: Feb. 8, 2018

(54) SUGGESTIONS FOR DIGITAL FORMS

(71) Applicant: ENTIT Software LLC, Sunnyvale, CA (US)

(72) Inventors: Haim Litvak, Yehud (IL); Shiran Gabay, Yehud (IL); Yariv Snapir, Yehud (IL); Sergey Steblin, Yehud (IL)

(21) Appl. No.: 15/556,193

(22) PCT Filed: Mar. 20, 2015
(86) PCT No.: PCT/US2015/021714

§ 371 Date: Sep. 6, 2017

(51) Int. Cl. G06F 17/24; G06F 17/27

(52) U.S. Cl. CPC G06F 17/243; G06F 17/276; G06F 3/0482

(57) ABSTRACT

Suggestions for filling a digital form may be provided. Input text may be received. The input text may be caused to be output into a first fillable field of the digital form. Suggestions may be determined for filling a second fillable field of the digital form based on the input text and a search of a plurality of data sources. The determined suggestions may be caused to be output into the second fillable field of the digital form.

### BACKGROUND

Information technology (IT) related problems may be reported by users. For example, a user may provide a description of a problem to an IT agent, who may then coordinate a response to the description of the problem.

### BRIEF DESCRIPTION

Some examples are described with respect to the following figures:

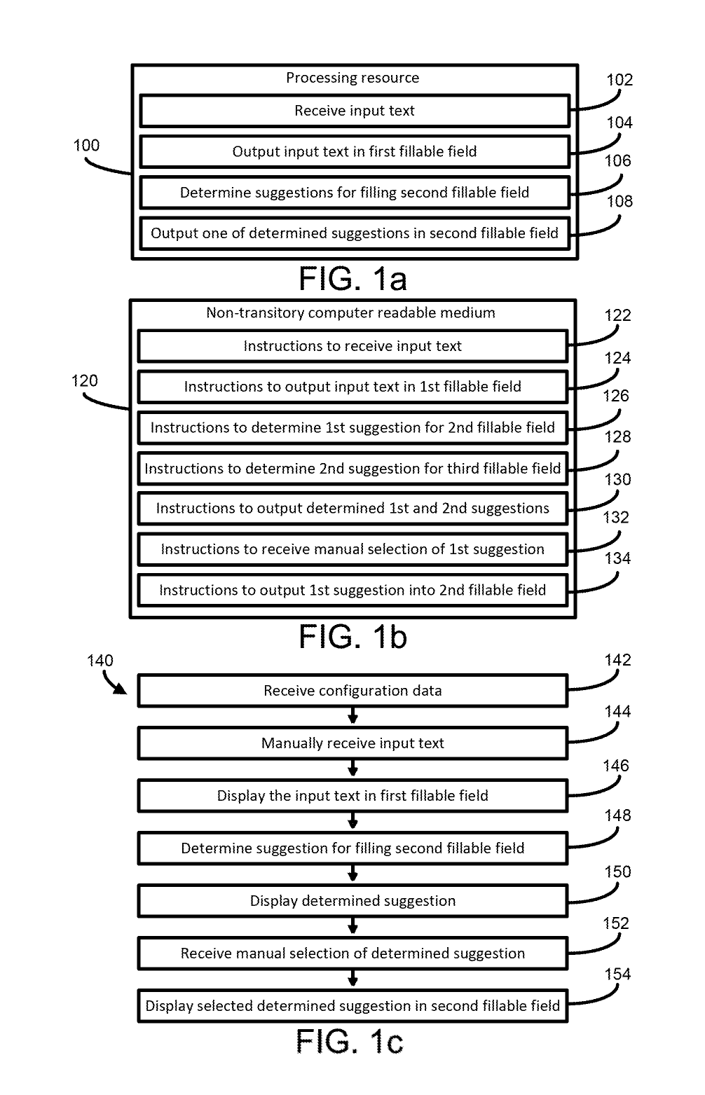

FIG. 1a is a block diagram illustrating a system for providing suggestions for filling a digital form according to some examples;

FIG. 1b is a block diagram illustrating a non-transitory computer readable storage medium according to some examples;

FIG. 1c is a flow diagram illustrating a method for providing at least one suggestion for filling a digital form according to some examples;

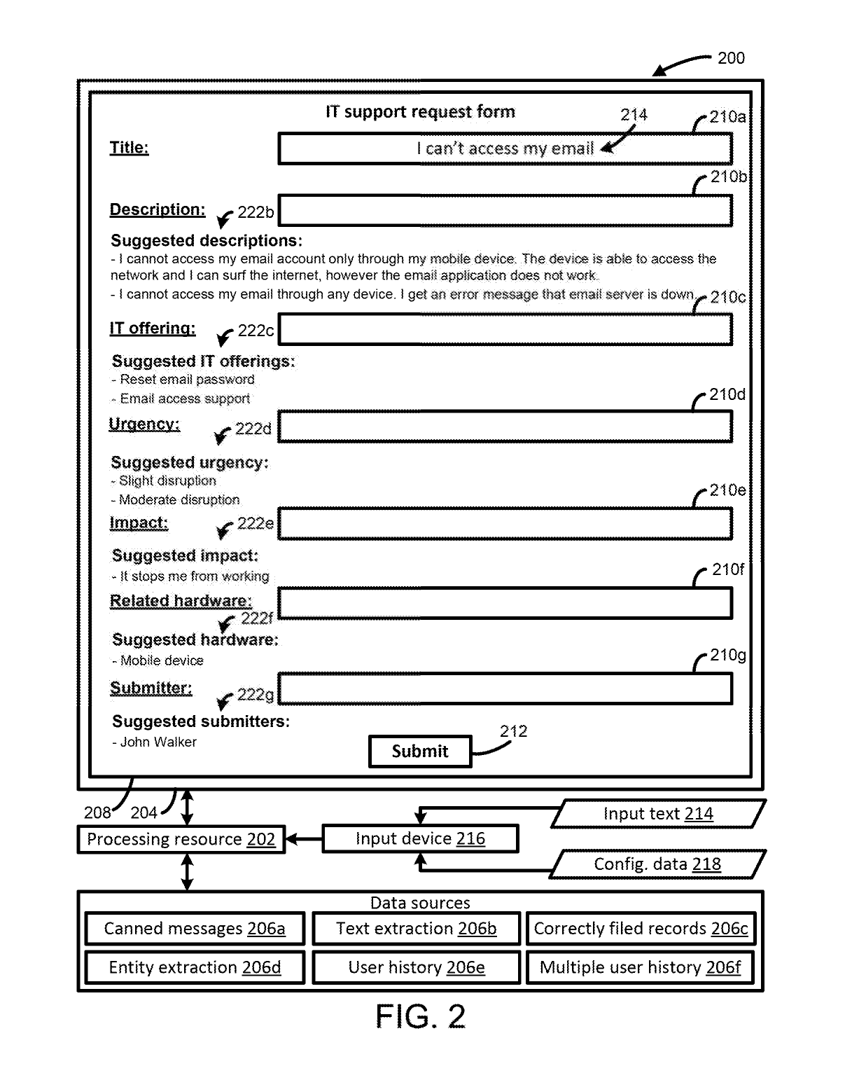

FIG. 2 is a block diagram illustrating a system for providing suggestions for filling a digital form according to some examples; and

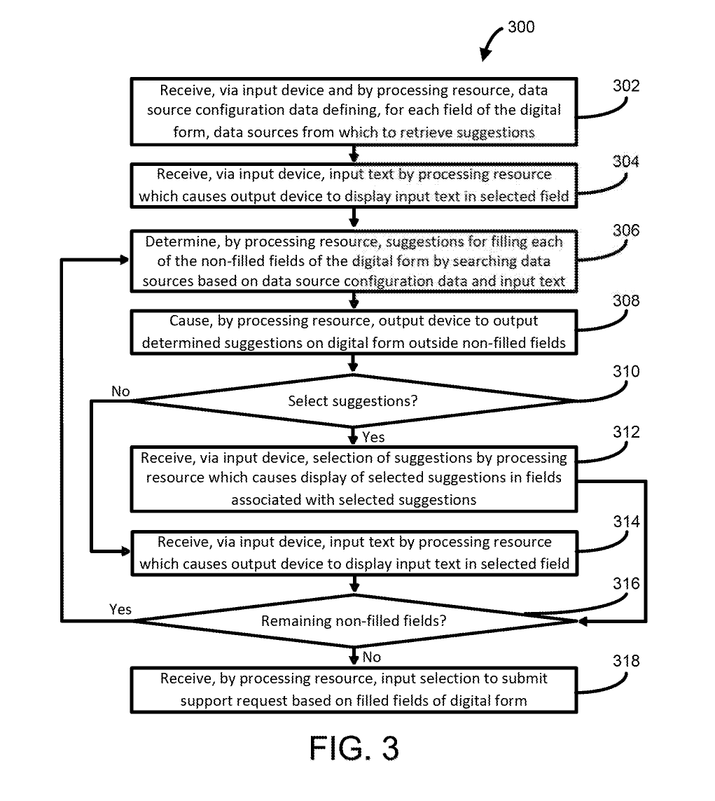

FIG. 3 is a flow diagram illustrating a method of providing suggestions for filling a digital form according to some examples.

### DETAILED DESCRIPTION

The following terminology is understood to mean the following when recited by the specification or the claims. The singular forms “a,” “an,” and “the” mean “one or more.” The terms “including” and “having” are intended to have the same inclusive meaning as the term “comprising.” The term “text” is intended to include alphanumeric characters and/or special characters.

In some examples, digital forms such as IT support request forms may be cumbersome to complete by IT agents assigned to solving a problem defined in the IT support request form. Accordingly, the present disclosures allows, in some examples, for filling digital forms by searching multiple different data sources each of which e.g. may be suitable for providing particular suggestions for filling the digital forms. The present disclosure allows, in some examples, for filling fillable fields of digital forms through an iterative process based on continued feedback by the user. For example, after entering input text in a first fillable field, a user may select a provided suggestion for a second fillable field, and a new suggestion may then be provided for a third fillable field based on the user's inputs of the input text and the selected suggestion. In some examples, these techniques may allow for filling digital forms efficiently, while reducing the number of questions that the IT agent or user has to answer. This may allow the problem to be addressed more quickly.

Although examples disclosed herein are discussed in the context of IT support request forms and IT agents, the present disclosure encompasses using these examples in the context of any suitable digital form which any suitable user and not just an IT agent may use.

FIG. 1a is a block diagram illustrating a system 100 for providing suggestions for filling a digital form according to some examples. The system 100 includes a processing resource 102 to receive 104 input text, to cause 106 the input text to be output into a first fillable field of the digital form, to determine 108 suggestions for filling a second fillable field of the digital form based on the input text and a search of a plurality of data sources, and to cause 110 one of the determined suggestions to be output into the second fillable field of the digital form.

FIG. 1b is a block diagram illustrating a non-transitory computer readable storage medium 120 according to some examples. The non-transitory computer-readable medium comprising instructions 122 that, when executed by a processor, cause the processor to receive input text. The non-transitory computer-readable medium comprising instructions 124 that, when executed by a processor, cause the processor to output the input text into a first fillable field of a digital form. The non-transitory computer-readable medium comprising instructions 126 that, when executed by a processor, cause the processor to determine a first suggestion for filling a second fillable field of the digital form based on the input text and based on a first search of at least one data source. The non-transitory computer-readable medium comprising instructions 128 that, when executed by a processor, cause the processor to determine a second suggestion for filling a third fillable field of the digital form based on the input text and based on a second search of the at least one data source. The non-transitory computer-readable medium comprising instructions 130 that, when executed by a processor, cause the processor to output the determined first and second suggestions on the digital form outside of the second and third fillable fields for selection. The non-transitory computer-readable medium comprising instructions that, when executed by a processor, cause the processor to receive 132 a manual selection of the determined first suggestion. The non-transitory computer-readable medium comprising instructions 134 that, when executed by a processor, cause the processor to output the selected determined first suggestion into the second fillable field of the digital form.

FIG. 1c is a flow diagram illustrating a method 140 for providing at least one suggestion for filling a digital form according to some examples. At 142, configuration data defining that a search for the suggestions is to be performed on a plurality of data sources may be received. At 144, input text may be manually received. At 146, the input text may be displayed in a first fillable field of the digital form. At 148, the at least one suggestion may be determined for filling a second fillable field of the digital form based on the input text, the configuration data, and the search of the plurality of data sources. At 150, the determined at least one suggestion may be displayed on the digital form adjacent to the second fillable field for selection. At 152, a manual selection of a suggestion of the at least one determined suggestion may be received. At 154, the selected determined suggestion of the at least one suggestion may be displayed in the second fillable field of the digital form.

FIG. 2 is a simplified isometric illustration of a system 200 for providing suggestions for filling a digital form according to some examples. Each of the components of the system 200 may be connected to each other through any type of connection, e.g. a wired or wireless connection. In some examples, the components may be part of a network such as a local area network (LAN), wide area network (WAN), intranet, the Internet, or any other network. For example, the components may be located at different nodes of a network. The system 200 may be operated as described further below with reference to the flow diagram of FIG. 3.

The system 200 may include a processing resource 202. Any of the operations and methods disclosed herein (e.g. in FIG. 3) may be implemented and controlled using the processing resource 202. The processing resource 202, as understood herein, comprises (1) a non-transitory computer-readable storage medium comprising instructions to perform operations and methods disclosed herein, and a processor coupled to the non-transitory computer-readable storage medium to execute the instructions or (2) circuitry to perform the operations and methods disclosed herein.

The processor may be to execute instructions that may implement the methods described herein. The processor may, for example, be a microprocessor, a microcontroller, a programmable gate array, an application specific integrated circuit (ASIC), a computer processor, or the like. The processor may, for example, include multiple cores on a chip, multiple cores across multiple chips, multiple cores across multiple devices, or combinations thereof. In some examples, the processor may include at least one integrated circuit (IC), other control logic, other electronic circuits, or combinations thereof.

In some examples, the processor may be in communication with a computer-readable storage medium, e.g. via a communication bus. The computer-readable storage medium may include a single medium or multiple media. For example, the computer readable storage medium may include one or both of a memory of the ASIC, and a separate memory in the processing resource 202. The computer readable storage medium 216 may be any electronic, magnetic, optical, or other physical storage device. For example, the computer-readable storage medium may be, for example, random access memory (RAM), static memory, read-only memory, an electrically erasable programmable read-only memory (EEPROM), a hard drive, an optical drive, a storage drive, a CD, a DVD, and the like. The computer-readable storage medium may be non-transitory. The computer-readable storage medium may store, encode, or carry computer executable instructions that, when executed by the processor, may cause the processor to perform any of the methods or operations disclosed herein according to various examples. In other examples, the processing resource 202 may not include a computer-readable storage medium, and the processor may comprise circuitry to perform any of the methods or operations disclosed herein without executing separate instructions in a computer-readable storage medium.

In some examples, the processing resource 202 may comprise a single processing resource, and in other examples the processing resource 202 may comprise processing resources distributed, e.g. across a network, such that e.g. one of the processing resources may be perform elements of the operations and methods disclosed herein and another of the processing resources may perform other elements of the operations and methods disclosed herein, etc.

The system 200 may support direct user interaction via input and output. For example, the system 200 may include an output devices 204 coupled to the processing resource 202, such as a liquid crystal display (LCD), video monitor, touch screen display, a light-emitting diode (LED), or other output devices. The output devices 204 may be responsive to instructions to display textual or graphical information or objects, for example digital form 208.

The digital form 208 may, as shown in the example of FIG. 2, be an IT support request form (e.g. IT service ticket). The digital form 208 may include fillable fields 210a-g, which may be to receive information regarding an IT-related problem. The fillable fields 210a-g may include a title field 210a to receive a title of the problem, a description field 210b to receive a detailed description of the problem, IT offering field 222c to receive a description of an IT offering requested by the user (e.g. submitter) to solve the problem, urgency field 222d to receive a description of the urgency for solving the problem, impact field 222e to receive a description of the impact to the user (e.g. submitted) due to the problem, related hardware field 222f to receive a description of the hardware, and submitter field 222g to receive an identification (e.g. name) of the user (e.g. submitter). In some examples, the fillable fields 210a-g may comprise free-form text fields, drop-down menus, or other type of fields. The digital form 208 may also display suggestions 222b-222g for filling the fillable fields 210a-g, as will be described in more detail.

Additionally, for example, the system 200 may include a user input devices 216 coupled to the processing resource 202, such as a keyboard, touchpad, buttons, keypad, dials, mouse, track-ball, card reader, or other input devices. In some examples, each engine of the processing resource 202 may be coupled to its own user input device 216. The user input devices 216 may be to receive input text 214 and configuration data 218 to provide to the processing resource 202 which may be to provide suggestions 222b-222g for filling the digital form 208 based on the input text 214 and configuration data 218.

The system may include data sources 206a-f coupled to the processing resource 202. Each of the data sources 206a-f may be removable by an administrator, and additional data sources may be added by the administrator, to customize the system 200. Each of the data sources 206a-f may be separate from each other. For example, the data sources 206a-f may be distributed across a network at different nodes of the network. Each of the data sources 206a-f may be used to extract text that may be used to fill any of the fillable fields 210a-g.

In some examples, the system may include (1) a canned messages data source 206a, which may include a repository of canned messages (e.g. problem descriptions and problem solutions), which are predetermined responses to known questions; (2) a correctly filed records data source 206b, which may include a repository of records of previously submitted digital forms, e.g. which were used (e.g. successfully used) by an IT agent to solve a problem specified in the digital form (In some examples, the natural language search may involve identifying configuration items (CIs) related to; (3) a free-form text extraction data source 206c, which may include a repository of text associated with IT service management and IT problems; and (4) an entity extraction data source 206d, which may include a repository of entities, such as identifications (e.g. names) of any of persons, organizations, products, hardware, etc.; (5) a user history data source 206e, which may include a repository of user history of the user (e.g. recent and/or popular selections) who submitted the support request; and (6) a multiple user history data source 206f, which may include a repository of history of multiple users (e.g. recent and/or popular selections) who submitted past support requests.

In examples, each of the data sources 206a-d may be store data in the form of structured data, unstructured data, or combinations thereof. Structured data may refer to data that follows a fixed data model or schema. Structured data may thus be stored in fixed fields within a record or file, as specified by the data model. Examples of structured data may thus include data stored as part of a relational database, NoSQL database, fixed spreadsheet field, an extensible markup language (XML) file, data warehouse storage, enterprise system record, accounting record, statistical storage, sensor record, web log, financial transaction log, or as part of a dataset according to any specific data model or data schema. Unstructured data may refer to data that does not follow a fixed data model or schema. In that regard, unstructured data may not be stored in a particular fixed location as set forth by the data model. In that regard, unstructured data may refer to free form text or data that is not stored in a predetermined field of a data file. Unstructured data may also be referred to as an unstructured document, and a data file may include multiple unstructured documents or an unstructured document may span across multiple data files. Unstructured documents may thus found in text or word processing documents, web pages, social sites, image files, e-mail messages, digital audio and/or video files, and more. Examples of structured data may thus include data stored as part of an operational database.

In some examples, any suitable search method may be used for any of the data sources 206a-f. In some examples, data, e.g. text, may be extracted from the data sources 206a-d by the processing resource 202 using a natural language search with input text 214 used as a search term. A natural language search takes a search term as input, and compares the term to data in a data source to generate a relevance ranking items in the data source. The comparison may be performed using any suitable natural language processing instructions (e.g. algorithms). The data items with the highest relevance rankings may be returned. In some examples, the natural language search may involve identifying configuration items (CIs) associated with data in the data sources 206a-d, for example CIs may be found in a user's computing device (e.g. mobile device that is to be identified in suggestion 222f) that are related to past completed IT support requests.

In some examples, for the user history data source 206e and the multiple user history data source 206f, the search may involve identifying the most recent or the most popular data items in the data sources 206e-f.

FIG. 3 is a flow diagram illustrating a method 300 of providing suggestions for filling a digital form according to some examples. In some examples, the orderings shown may be varied, some elements may occur simultaneously, some elements may be added, and some elements may be omitted. In describing FIG. 3, reference will be made to FIG. 2.

In some examples, initially, the output device 204 may be outputting output (e.g. electronically output such as display on a screen) the digital form 208.

At 302, configuration data 218 may be received by the processing resource 202 e.g. via manual input into an input device 216 by an administrator or an IT agent. The configuration data 218 may define, for each fillable field 210a-g, which data sources 206a-f the processing resource 202 is to access when searching for suggestions for filling the respective fillable field 210a-g.

In some examples where multiple data sources 206a-f are to be accessed for providing suggestions for a given fillable field 210a-g, then the configuration data 218 may define an order in which the suggestions are given (and the ranking of the data sources 206a-f to be accessed). The order may be based on, for example, the order that the data source 206a-f is defined by the administrator or IT agent when defining the configuration data, e.g. the most recently selected data source may have its corresponding suggestion listed first, or e.g. the administrator or IT agent may rank the relevance of the selected data sources 206a-f. In examples in which one data source 206-a-f is selected by the user for a given fillable field 210a-g, then an ordering may not be defined for that fillable field 210a-g.

In some examples where multiple data sources 206a-f are to be accessed for providing suggestions for a given fillable field 210a-g, some of the suggestion may be based on multiple data sources 206a-f rather than each being based on one data source 206a-f.

In some examples, for each fillable field 210a-g, multiple suggestions may be provided for each data source 206a-f that is to be accessed for providing suggestions for the respective fillable field 210a-g, e.g. based on whether each of the suggestions exceeds a relevance ranking (e.g. exceeds a probability of match) in natural language search.

In some examples, the configuration data 218 may also include search arguments to be used for searching the data sources 206a-f. In some examples, the configuration data 218 may also define, for each fillable field 210a-g, whether to use suggestions for other fillable fields 210a-g as input text when searching data sources 206a-f.

In some examples, the configuration data 218 may define which data sources 206a-f to access and which search arguments to use based on the input text 214 and/or based on which of the fillable fields 210a-g have been filled with input text 214.

In some examples, although not shown in FIG. 2, some fillable fields may not support suggestions, and therefore the configuration data 218 may not define any data sources 206a-f for those fillable fields.

In the example of FIG. 2, the configuration data 218 defines that, if input text 214 is entered into the title field 210a but not into other fields 210b-210g, (1) the description suggestions 222b may be based on the correctly filed records data source 206c (the search at 306 may return “I cannot access my email account only through my mobile device. The device is able to access the network and I can surf the internet, however the email application does not work” which is ordered first), and the canned messages data source 206a (the search at 306 may return “I cannot access my email through any device. I get an error message that email server is down.” which is ordered second); (2) the IT offering suggestions 222c may be based on the correctly filed records data source 206c, e.g. an IT offering associated with a submitted request (the search at 306 may return “Reset email password” which ordered first), and the multiple user history data source 206f (the search at 306 may return “Email access support” which is ordered second); (3) the urgency suggestions 222d may be based on the correctly filed records data source 206c, e.g. an urgency associated with a submitted request (the search at 306 may return “Slight disruption” which is ordered first), and the free-form text extraction data source 206b (the search at 306 may return may return “Moderate disruption” which is ordered second); (4) the impact suggestions 222e may be based on the correctly filed records data source 206c, e.g. an impact associated with a submitted request (the search at 306 may return “It stops me from working”); (5) the related hardware suggestions 222f may be based on the entity extraction data source 206d (the search at 306 may return “Mobile device”); and (6) the submitter suggestions 222f may be based on the user history data source 206e (the search at 306 may return “John Walker”).

In the example of FIG. 2, the configuration data 218 may also define that the search terms used for searching the data sources 202a-f for generating the suggestions 222c-222f may be based on both the input text 214 in title field 210a and on the description suggestions 222b which may further define the problem compared to the input text 214 in the title field 210a.

In the example of FIG. 2, no suggestions are shown for the title field 210a because input text 214 is input therein, however the configuration data 218 may define which data sources 206a-206f to search for determining suggestions in the event that the title field 210a is not filled and instead another fillable field 210b-g is filled.

The method 300 may proceed from 302 to 304.

At 304, input text 214 may be received by the processing resource 202 e.g. via manual input into an input device 216 by the IT agent assigned to the problem. In some examples, in response, the processing resource 202 may cause the output device 204 to output the input text 214 in any of the fillable fields 210a-g. In the example of FIG. 2, the input text 214 is filled in the title field 210a, and describes a problem e.g. an IT-related problem, experienced by a user (e.g. the submitter to be identified in fillable field 222g). In the example of FIG. 2, the input text 214 is “I can't access my email”.

In some examples, a user may provide the input text 214 to an IT agent. In some examples, the input text 214 may be provided by the user to the IT agent through a computing device e.g. by sending an email to the IT agent or by filling the input text 214 into a digital form on a webpage or IT system. In some examples, the input text 214 may be provided by the user to the IT agent through a telephone system. The IT agent may then input the input text 214 into the input device 216. In some examples, the user and the IT agent may be affiliated (e.g. employees) with an organization, e.g. a corporation, a non-profit organization, and/or a government agency. The IT agent may be responsible for solving IT problems in the organization.

In some examples, the input text 214 may be received at a different input device 216 than the input device 216 in which the configuration data 218 is to be received, for example if the administrator provides the configuration data 218 and the IT agent provides the input text 214.

The method 300 may proceed from 304 to 306.

At 306, the processing resource 202 may determine suggestions 222b-222g. The determination may be made by searching (e.g. natural language searching) the data sources 206a-f using the input text 214 as a search term and based on the configuration data 218 (e.g. search arguments, and which data sources 206a-f to search for each suggestion e.g. based on which fillable fields 210a-210g are filled, etc.).

The method 300 may proceed from 306 to 308.

At 308, the processing resource 202 may cause the output device 204 to output the determined suggestions 222b-g. Each of the suggestions 222b-g may be output outside of (e.g. adjacent to and/or below) its corresponding fillable field 210b-g.

The method 300 may proceed from 308 to 310.

At decision 310, the IT agent may decide whether to select any of the suggestions 222b-g to fill its corresponding fillable field 210b-g. If the IT agent makes a selection, the method 300 may proceed from 310 to 312, otherwise the method 300 may proceed from 310 to 314.

At 312, a selection of one of the suggestions 222b-g may be received by the processing resource 202 e.g. via manual input into an input device 216 by the IT agent. In some examples, in response, the processing resource 202 may cause the output device 204 to output the input text 214 in the one of the fillable fields 210a-g associated with the selected one of the suggestion 222b-g.

The method 300 may proceed from 312 to 316.

In an example, “Slight disruption”, which is one of the urgency suggestions 222d, may be selected, causing output of “Slight disruption” in fillable field 210d.

At 314, as described earlier relative to 304, additional input text may be received by the processing resource 202 e.g. via manual input into an input device 216 by the IT agent. In some examples, in response, the processing resource 202 may cause the output device 204 to output the additional input text in any of the fillable fields 210a-g that are not already filled. In the example of FIG. 2, the input text 214 is already filled in the title field 210a, therefore, the additional input text can be in any of the other fillable fields 210b-g. In one example, the additional text “Major disruption” may be input by the IT agent based on a communication from the user to indicate that there was a major disruption, for example because the urgency suggestions 222d mention options for a “Slight disruption” or “Moderate disruption” but not for a “Major disruption.”

The method 300 may proceed from 314 to 316.

At decision 316, the processing resource 202 may determine whether any of the fillable fields 210a-g remain unfilled. If each of the fillable fields 210a-g is filled, then the method 300 may proceed to 318. If any of the fillable fields 210a-g remain unfilled, then the method 300 may proceed to from 316 to 306, and, for example, the method 300 may iterate between 306 to 316 as many times as needed until each of the fillable fields 210a-g are filled.

At 318, after each of the fillable fields 210a-g are filed, a selection of the submit button 212 may be received by the processing resource 202 via e.g. input into an input device 216 by the IT agent. In some examples, in response, the processing resource 202 may cause the digital form 208 with the filled fillable fields 210a-g to be saved and/or submitted, such that the IT agent can solve the problem, or another IT agent to whom the request is submitted and sent may solve the problem. Additionally, the data from the filled digital form 208 may be stored in each of the data sources 206a-f or a subset of the data sources 206a-f for future iterations of the method 300.

All of the features disclosed in this specification (including any accompanying claims, abstract and drawings), and/or all of the elements of any method or process so disclosed, may be combined in any combination, except combinations where at least some of such features and/or elements are mutually exclusive.

In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

1. A system for providing suggestions for filling a digital form, the system comprising:
a processing resource to:
receive input text;
cause the input text to be output into a first fillable field of the digital form;
determine suggestions for filling a second fillable field of the digital form based on the input text and a search of a plurality of data sources; and
cause one of the determined suggestions to be output into the second fillable field of the digital form.

2. The system of claim 1 wherein the processing resource is to receive configuration data defining that the search for the suggestions is to be performed on the plurality of data sources, wherein the determination of the suggestions is further based on the configuration data.

3. The system of claim 1 wherein the processing resource is to:
cause the determined suggestions to be output on the digital form outside of the second fillable form; and
receive a manual selection of the one of the determined suggestions,
wherein the selected one of the determined suggestions is output into the second fillable field based on the manual selection.

4. The system of claim 1 wherein the search is a natural language search of the plurality of data sources.

5. The system of claim 1 wherein the plurality of data sources comprise at least two of a canned messages data source comprised canned messages, a free-form text extraction data source comprising free-form text, an entity extraction data source comprising entity data, a correctly filed records data source comprising records of correctly filed digital forms, a user history comprising a history of a user who submitted the input text, and a multiple user history comprising a history of multiple users who submitted input text into digital forms.

6. The system of claim 1 wherein a first suggestion of the suggestions is from a first data source of the plurality of data sources and the second suggestion of the suggestions is from a second data source of the plurality of data sources.

7. The system of claim 1 wherein the processing resource is to;
determine an additional suggestion for filling a third fillable field of the digital form based on the input text and a search of a plurality of data sources; and
cause determined additional suggestion to be output into the third fillable field of the digital form.

8. The system of claim 1 wherein the digital form is an IT support request form, wherein the first and second fillable fields comprise two of a title field, a description field, an IT offering field, an urgency field, an impact field, a related hardware field, and a submitter field.

9. The system of claim 1 wherein a data source of the plurality of data sources comprises structured data.

10. The system of claim 1 wherein a data source of the plurality of data sources comprises unstructured data.

11. A non-transitory computer-readable medium comprising instructions that, when executed by a processor, cause the processor to:
receive input text;
output the input text into a first fillable field of a digital form;
determine a first suggestion for filling a second fillable field of the digital form based on the input text and based on a first search of at least one data source;
determine a second suggestion for filling a third fillable field of the digital form based on the input text and based on a second search of the at least one data source;
output the determined first and second suggestions on the digital form outside of the second and third fillable fields for selection;
receive a manual selection of the determined first suggestion; and
output the selected determined first suggestion into the second fillable field of the digital form.

12. The non-transitory computer-readable medium of claim 11 wherein the first search is of a first data source of the at least one data source, and the second search is of a second data source of the at least one data source.

13. The non-transitory computer-readable medium of claim 11 further comprising instructions that, when executed by a processor, cause the processor to:
determine a third suggestion for filling the third fillable field of the digital form based on the input text, the selected determined first suggestion, and based on a third search of the at least one data source;
output the determined third suggestion on the digital form outside of the third fillable field for selection;
receive a manual selection of the determined third suggestion; and
output the determined third suggestion into the third fillable field of the digital form.

14. The non-transitory computer-readable medium of claim 11 further comprising instructions that, when executed by a processor, cause the processor to receive configuration data defining that the first search for the first suggestion is to be performed on the first data source and that the second search for the second suggestion is to be performed on the second data source, wherein the determinations of the first and second suggestions are further based on the configuration data.

15. A method for providing at least one suggestion for filling a digital form, the method comprising:
receiving configuration data defining that a search for the suggestions is to be performed on a plurality of data sources;
manually receiving input text;
display the input text in a first fillable field of the digital form;
determine the at least one suggestion for filling a second fillable field of the digital form based on the input text, the configuration data, and the search of the plurality of data sources; and
display the determined at least one suggestion on the digital form adjacent to the second fillable field for selection;
receive a manual selection of a suggestion of the at least one determined suggestion; and
display the selected determined suggestion of the at least one suggestion in the second fillable field of the digital form.
